(19) United States
(12) Patent Application Publication
(10) Pub. No.: US 2015/0240840 A1
(43) Pub. Date: Aug. 27, 2015

(54) ANGULAR MOMENTUM PROPULSION APPARATUS AND METHOD

(71) Applicant: George O. Schur, Elkhart Lake, WI (US)

(72) Inventor: George O. Schur, Elkhart Lake, WI (US)

(21) Appl. No.: 14/299,223

(22) Filed: Jun. 9, 2014

Related U.S. Application Data
(63) Continuation-in-part of application No. 14/190,349, filed on Feb. 26, 2014, now abandoned.

(51) Int. Cl. F15B 7/00; F15B 7/06

(52) U.S. Cl. CPC F15B 7/008; F15B 7/06

(57) ABSTRACT

An angular momentum propulsion apparatus is disclosed that imparts motion on an object. The propulsion apparatus includes a support structure and a first tube assembly coupled to the support structure. The first tube assembly includes a first curved portion, a second curved portion coupled to the first curved portion by a pair of angled joints, and a pump configured to pump a fluid through the first and second curved portions of the first tube assembly. The propulsion apparatus further includes a motor coupled to the support structure and a control system coupled to the motor and the pump and configured to propel the propulsion apparatus by simultaneously controlling a rotation of the support structure and a flow of the fluid within the first tube assembly.

### CROSS-REFERENCE TO RELATED APPLICATION

The present application is a continuation-in-part of, and claims priority to, U.S. non-provisional application Ser. No. 14/190,349, filed Feb. 26, 2014, the disclosure of which is incorporated herein by reference in its entirety.

### BACKGROUND OF THE INVENTION

Embodiments of the invention relate generally to an angular momentum propulsion apparatus, and more particularly, to an angular momentum propulsion apparatus constructed to impart motion on an object, such as a land, air, or space vehicle, and a method of controlling directional motion thereof.

With ever-increasing fuel prices, much research and development in recent years has been directed to improving vehicle fuel efficiency and reducing fuel consumption through the development of new technologies for hybrid-powered and all-electric vehicles. Further, while these new vehicle technologies may reduce fuel consumption for land and air vehicles, these technologies are generally inapplicable to space vehicles, which operate in the absence of air and a variation of gravity. The unique operating environment of space vehicles also imposes certain operating and design constraints on these vehicles. For example, a space vehicle cannot be refueled in a similar manner as a land or air vehicle after a space vehicle is launched out of the atmosphere. As such, the operating lifespan of a space vehicle is limited by the amount of fuel that the space vehicle can hold at the time of launch. Also, due to the harsh operating conditions of space and the difficulties (or, in many cases, impossibilities) associated with in-field repair and maintenance, it is desirable for the components of a space vehicle to be rugged and have a minimal number of complex electronic and mechanical components.

In order to address these issues, a number of technologies have been developed for land, air and space vehicles to achieve vehicle propulsion and directional control with improved efficiency. For example, gyroscopic devices have been incorporated in aircraft to sense or measure a change in orientation of the vehicle during operation. These stabilization systems operate based on the inertial property that a spinning gyroscope causes the spin axis of the gyroscope to resist change. When the gyroscope device senses an undesired change in vehicle orientation, the independent propulsion motors and associated steering controls of the vehicle operate to correct the orientation of the vehicle.

Attempts have also been made to apply gyroscopic principles to achieve linear translation of a vehicle from a translation of rotary motion to linear motion using components such as flywheels. These systems operate on the principle of gyroscopic precession, which states that a gyroscope will rotate about an axis that is at right angles to a force applied to the spin axis of the rotating object. While these systems may achieve some unidirectional motion, they are constructed using multiple gyroscopic devices that include a complex mechanical construction and that must be controlled in a precise synchronized manner in order to prevent undesirable cancellation of the processional force during operation. Further, such devices do not permit control of the direction of linear motion of the device.

Therefore, it would be desirable to design an apparatus and method that achieves vehicle propulsion in an efficient manner using gyroscopic principles to minimize the use of combustive fuels to propel the vehicle. It would further be desirable for such an apparatus to have a simplified control system and simplified overall construction that minimizes manufacturing costs.

### BRIEF DESCRIPTION OF THE INVENTION

According to one aspect of the invention, a propulsion apparatus includes a support structure and a first tube assembly coupled to the support structure. The first tube assembly includes a first curved portion, a second curved portion coupled to the first curved portion by a pair of angled joints, and a pump configured to pump a fluid through the first and second curved portions of the first tube assembly. The propulsion apparatus further includes a motor coupled to the support structure and a control system coupled to the motor and the pump and configured to propel the propulsion apparatus by simultaneously controlling a rotation of the support structure and a flow of the fluid within the first tube assembly.

In accordance with another aspect of the invention, a method of propelling a vehicle includes pumping a fluid through a plurality of tube assemblies, each tube assembly having a pair of joints dividing the tube assembly into a first curved section and a second curved section, wherein the first curved section is oriented at an angle to the second curved section. The method further includes propelling the vehicle in a direction by simultaneously controlling rotation of support structures coupled to the plurality of tube assemblies, and controlling a rate of flow of the fluid within the plurality of tube assemblies.

In accordance with yet another aspect of the invention, a vehicle includes a vehicle body, a mounting platform positioned within the vehicle body, and a plurality of propulsion apparatuses. Each propulsion apparatus includes a rotatable plate coupled to the mounting platform and a plurality of tube assemblies coupled to the rotatable plate. Each tube assembly of the plurality of tube assemblies includes a first curved portion and a second curved portion oriented at an angle to the first curved portion, a fluid disposed within the first and second curved portions and a pump configured to pump the fluid through the first and second curved portions. The vehicle further includes at least one motor coupled to the plurality of propulsion apparatuses and configured to cause rotation of the rotating plates and a propulsion control system configured to affect a motion of the vehicle by regulating a speed of the rotation of the plurality of rotating plates and a rate of flow of the fluid in the plurality of tube assemblies.

Various other features and advantages will be made apparent from the following detailed description and the drawings.

### BRIEF DESCRIPTION OF THE DRAWINGS

The drawings illustrate preferred embodiments presently contemplated for carrying out the invention.

In the drawings:

FIG. 1 is a perspective view of a propulsion apparatus in accordance with one embodiment of the invention.

FIG. 2 is a side view of the propulsion apparatus of FIG. 1, according to one embodiment of the invention.

FIG. 3 is a top view of the propulsion apparatus of FIG. 1, according to one embodiment of the invention

FIG. 4 is a perspective view of a propulsion apparatus in accordance with another embodiment of the invention.

FIG. 5 is a side view of the propulsion apparatus of FIG. 4, according to an embodiment of the invention.

FIG. 6 is a top view of the propulsion apparatus of FIG. 4, according to an embodiment of the invention.

FIG. 7 is a schematic diagram of a vehicle incorporating multiple propulsion apparatuses of FIG. 1, according to one embodiment of the invention.

### DETAILED DESCRIPTION

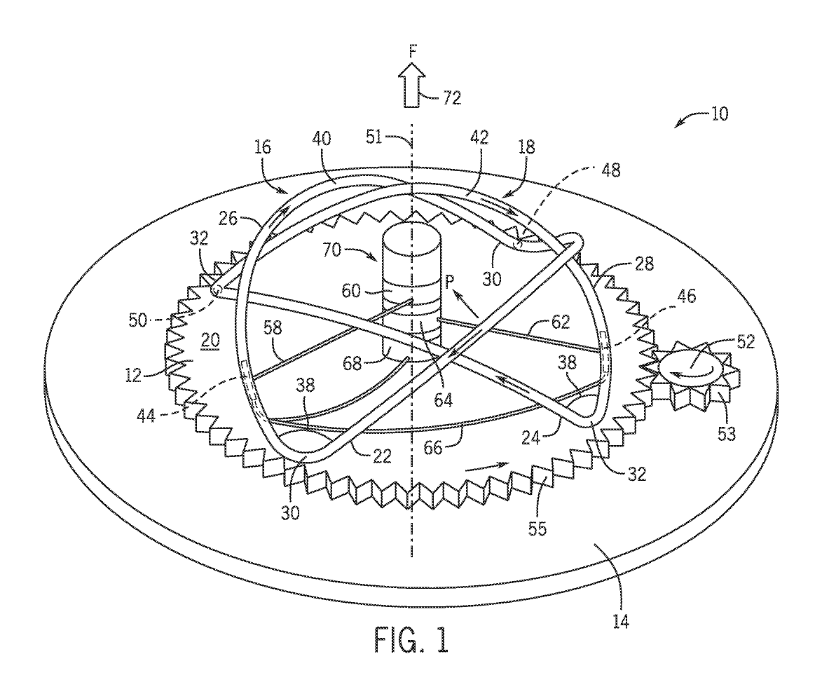

Referring to FIGS. 1-3, a perspective view, side view, and top view of an angular momentum propulsion apparatus 10 are illustrated, according to one embodiment of the invention. Propulsion apparatus 10 includes a support structure, rotating disk, or rotating plate 12 mounted on a base substrate 14.

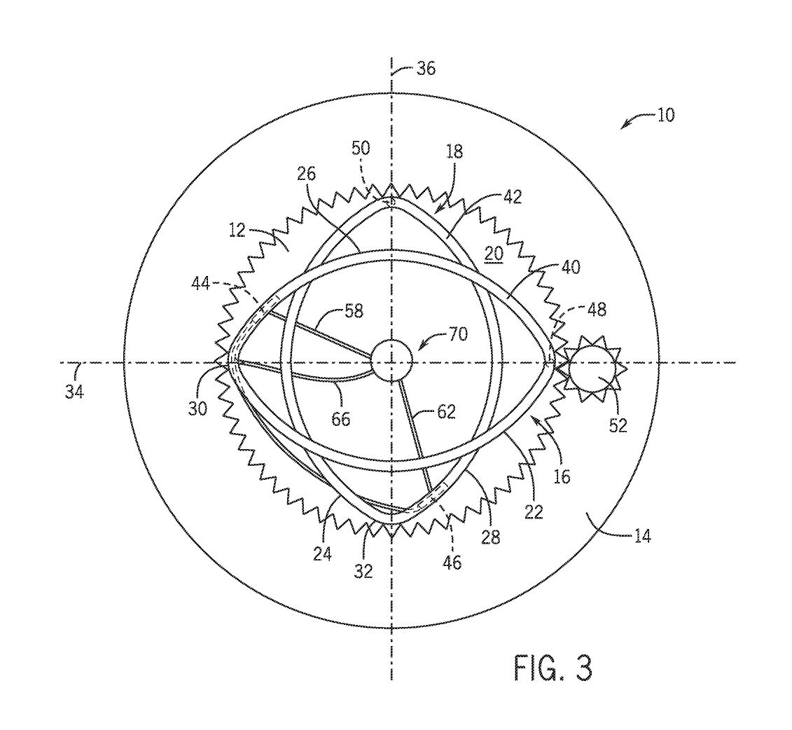

In the embodiment illustrated in FIGS. 1-3, propulsion apparatus 10 includes a pair of hollow tube assemblies 16, 18 mounted on a top surface 20 of rotating plate 12. While FIGS. 1-3 illustrate the use of two (2) hollow tube assemblies 16, 18 it is contemplated that propulsion apparatus 10 may include a single hollow tube assembly or more than two hollow tube assemblies. As shown, each tube assembly 16, 18 includes a respective first curved portion 22, 24 and a respective second curved portion 26, 28 connected via a respective pair of joints 30, 32 formed about a central axis 34, 36 (shown in FIG. 3), respectively, of the tube assembly 16, 18. According to an exemplary embodiment, the curvature and interior volume of first and second curved portions 22, 26 of tube assembly 16 and first and second curved portions 24, 28 of tube assembly 18 are substantially equal.

Tube assemblies 16, 18 are positioned on rotating plate 12 to be centered about a central rotational axis 51 of rotating plate 12. In the dual tube assembly embodiment illustrated in FIGS. 1-3, the central axis 34 of the tube assembly 16 is substantially co-planar with a top surface 20 of rotating plate 12, while the central axis 36 of tube assembly 18 is offset from the top surface 20 by a distance approximately equal to the diameter of the tube assembly 18, thereby allowing the tube assemblies 16, 18 to be centered about axis 51 in a stacked arrangement. As illustrated in FIG. 3, central axis 34 of tube assembly 16 is offset from central axis 36 of tube assembly 18 by approximately 90 degrees. In alternative embodiments having more than two tube assemblies centered about the central axis 51 of rotating plate 12, the central axes of the tube assemblies may be offset from one another by differing degrees such that the tube assemblies are aligned with the central axis 51 in a stacked arrangement.

First curved portion 22 and second curved portion 26 of tube assembly 16 are fluidically connected to one another at a pair of angled joints 30 to permit a fluid 40 to flow in a continuous loop through tube assembly 16. Likewise, a pair of angled joints 32 fluidically couple first curved portion 24 and second curved portion 28 of tube assembly 18 to permit a fluid 42 to flow in a continuous loop through tube assembly 18. As shown in FIG. 1, angle 38 of the pair of joints 30, 32 causes first curved portions 22, 24 and second curved portions 26, 28 of tube assemblies 16, 18 to be oriented generally orthogonal to one another. In one embodiment, angle 38 is approximately 90 degrees, however, angle 38 may be less than or greater than 90 degrees in alternative embodiments.

As shown in FIGS. 1-3, tube assemblies 16, 18 are arranged on rotating plate 12 such that joints 30, 32 are in contact with the top surface 20 of the rotating plate 12 and first and second curved portions 22-28 are spaced apart from the top surface 20. In one embodiment, tube assemblies 16, 18 are coupled to rotating plate 12 at at least one joint of its respective pair of joints 30, 32 via a weld or other attachment means.

A liquid pump 44 is positioned within tube assembly 16 and configured to pump fluid 40 through second curved portion 26 and first curved portion 22 in a continuous loop. Likewise, a liquid pump 46 is positioned within tube assembly 18 and configured to pump fluid 42 in a continuous loop through first curved portion 24 and second curved portion 28. An accumulator 48, 50 is also positioned within each tube assembly 16, 18 to permit for expansion and contraction of respective fluid 40, 42. According to various embodiments, fluid 40 and fluid 42 are liquids that remain in fluid form within the typical operation conditions of propulsion apparatus 10.

While FIGS. 1-3 depict pumps 44, 46 as being positioned within second curved portion 26, 28 and accumulators 48, 50 as being positioned within joint 30, 32, one skilled in the art will recognize that pumps 44, 46 and accumulators 48, 50 may be positioned at other locations within tube assemblies 16, 18 in alternative embodiments. Alternatively, one or both pumps 44, 46 may be positioned outside its respective tube assembly 16, 18 and fluidically coupled to tube assembly 16, 18 via a valve or other coupling device (not shown).

Propulsion apparatus 10 also includes a motor 52 configured to control the rotation of rotating plate 12 about central axis 51. In one embodiment of the invention, motor 52 includes a gear assembly 53 that is configured to intermesh with a corresponding gear assembly 55 coupled to or formed on rotating plate 12. It is contemplated that motor 52 is not limited to a single speed, but may be operated to rotate rotating plate 12 at a variable range of speeds and in clockwise and counterclockwise directions.

FIGS. 1-3 also illustrate the electrical connections between the various components of propulsion apparatus 10. In this configuration, a first lead wire 58 is electrically connected between pump 44 located in one tube assembly 16 and a first contact 60. A second lead wire 62 is electrically connected between pump 46 located in another tube assembly 18 and a second contact 64. Additionally, a ground lead wire 66 electrically connects pumps 44, 46 of each propulsion apparatus 10 to a ground contact 68. Any metal components of tube assemblies 16, 18 may be likewise grounded via ground lead wire 66.

In one embodiment of the invention, first contact 60, second contact 64, and ground contact 68 are each disposed on an electrical hub 70. As shown in FIGS. 1-3, electrical hub 70 is shaped as a cylinder and each contact 60, 64, 68 is disposed around the circumference of electrical hub 70 in order to maintain electrical contact between lead wires 58, 62, 66 with their respective contacts 60, 64, 68 as rotating plate 12 rotates about central axis 51. Further each contact 60, 64, 68 is vertically spaced apart from each other along electrical hub 70, so as to prevent electrical contact between contacts 60, 64, 68. It is contemplated that the electrical and ground contacts described herein may be constructed in alternative manners, such as, for example, using a non-centralized electrical hub.

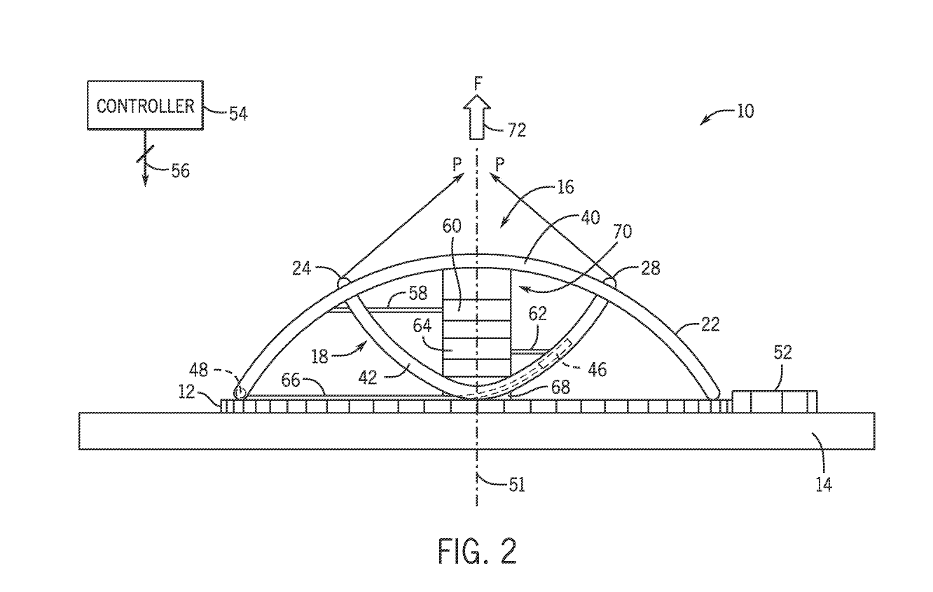

In one embodiment, propulsion apparatus 10 includes a controller or control system 54, schematically illustrated in FIG. 2, which is programmed to control operation of each pump 44, 46 and rotation of motor 52. Additionally, controller 54 may be connected to pumps 44, 46 and motor 52 via control lines 56. In one embodiment of the invention, motor 52 is controlled to rotate in a clockwise direction, thereby causing counter-clockwise rotation of rotating plate 12, and each pump 44, 46 is controlled to move fluid 40, 42 in a clockwise direction through its respective tube assembly 16, 18. Controller 54 may also be configured to control pumps 44, 46 to move fluid 40, 42 through its respective tube assembly 16, 18 in a counter-clockwise direction and/or at variable flow rates during operation for a reversed 180 degree pull. Further, controller 54 may be configured to control pump 44 to move fluid 40 through tube assembly 16 at a first flow rate and to control pump 46 to move fluid 42 through tube assembly 18 at second flow rate, different from the first flow rate.

Movement of propulsion apparatus 10 is accomplished by operating pumps 44, 46 to pump fluid through tube assemblies 16, 18 while simultaneously operating motor 52 of propulsion apparatus 10 to rotate rotating plate 12 about central axis 51. During the rotation, each fluid 40, 42 exerts a pull force (P) that acts against the inner wall of its respective tube assembly 16, 18, creating a resultant force in the direction of arrow 72 that acts to propel propulsion apparatus 10 in a given direction. The magnitude of the resultant force (F) may be selectively controlled by adjusting the velocity of fluid 40, 42 through tube assemblies 16, 18 and the rotational speed of rotating plate 12.

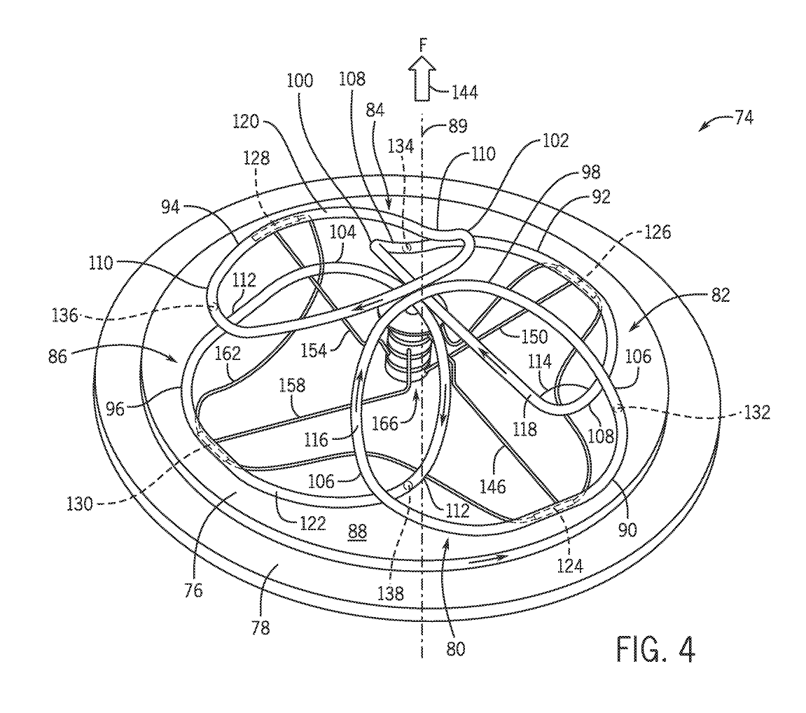

Referring now to FIGS. 4-6, a perspective view, side view, and top view of a propulsion apparatus 74 are shown, according to another embodiment of the invention. Similar to the embodiment described with respect to FIGS. 1-3, propulsion apparatus 74 includes a rotating plate 76 mounted on a base substrate 78.

In this embodiment of the invention, propulsion apparatus 74 includes a plurality of hollow tube assemblies 80, 82, 84, 86 mounted on a top surface 88 of rotating plate 76. While FIG. 4 shows the use of four (4) hollow tube assemblies 80, 82, 84, 86, it is contemplated that propulsion apparatus 74 may have more or less than four (4) hollow tube assemblies 80, 82, 84, 86. As shown, each tube assembly 80, 82, 84, 86 includes a respective first curved portion 90, 92, 94, 96 and a respective second curved portion 98, 100, 102, 104 fluidically coupled to one another via a respective pair of joints 106, 108, 110, 112 to permit a fluid 116, 118, 120, 122 to flow in a continuous loop through each respective tube assembly 80, 82, 84, 86. According to an exemplary embodiment, the curvature and interior volume of first and second curved portions 90, 92, 94, 96, 98, 100, 102, 104 are substantially equal.

As can be seen in FIGS. 4-6, first curved portions 90, 92, 94, 96 and second curved portions 98, 100, 102, 104 of tube assembly 80, 82, 84, 86 are oriented at an angle 114 obtuse to one another. In one embodiment, angle 114 is approximately 135 degrees, however, angle 114 may be less than or greater than 135 degrees in alternative embodiments.

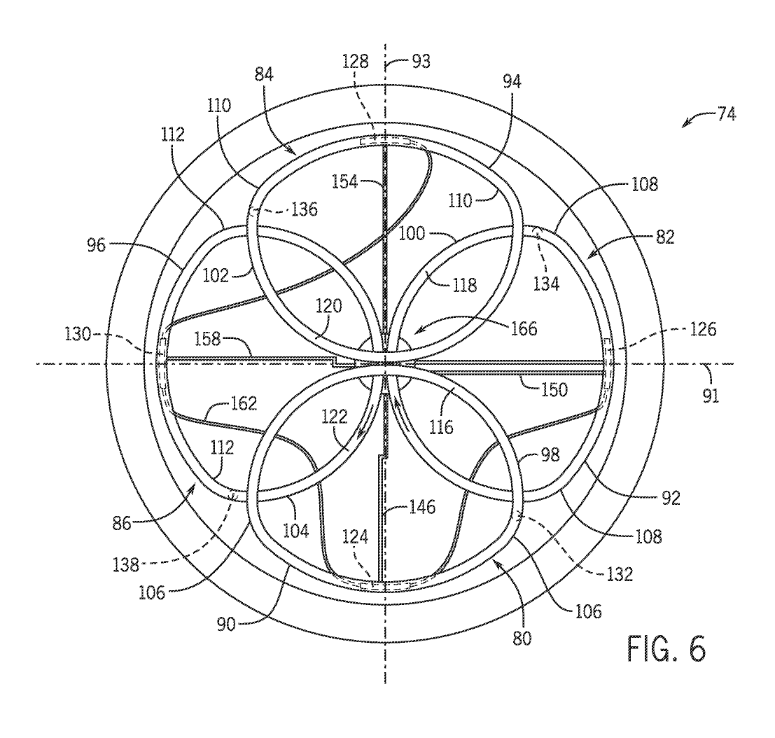

Tube assemblies 80-84 are arranged in a paired arrangement within propulsion apparatus 74, with tube assembly 82 and tube assembly 86 aligned with a first axis 91 and tube assembly 80 and 84 aligned with a second axis 93. In the embodiment of FIG. 6, the first axis 91 and second axis 93 are offset from one another by approximately 90 degrees. As shown in FIG. 6, the first curved portions 90-96 of each tube assembly 80-86 is positioned to be in contact with and substantially co-planar to the top surface 88 of rotating plate 76, while the second curved portions 98-104 are spaced apart from the top surface 88 of rotating plate 76. Tube assemblies 80-86 are arranged with respect to one another such that a center point of each second curved portion 98-104 is substantially aligned with a central rotating axis 89 of rotating plate 76.

A liquid pump 124 is positioned within tube assembly 80 and configured to pump fluid 116 through first and second curved portions 90, 98 in a continuous loop. Similarly, a liquid pump 126 is positioned within tube assembly 82 and configured to pump fluid 118 through first and second curved portions 92, 100. Likewise, a liquid pump 128 is positioned within tube assembly 84 and configured to pump fluid 120 through first and second curved portions 94, 102. In addition, a liquid pump 130 is positioned within tube assembly 86 and configured to pump fluid 122 through first and second curved portions 96, 104. An accumulator 132, 134, 136, 138 is also positioned within each tube assembly 80, 82, 84, 86 to permit for expansion and contraction of fluid 116, 118, 120, 122. According to various embodiments, fluids 116, 118, 120, 122 are liquids that remain in fluid form within the typical operation conditions of propulsion apparatus 74.

While FIGS. 4-6 depict pumps 124, 126, 128, 130 as being positioned within first curved portions 90, 92, 94, 96 and accumulators 132, 134, 136, 138 as being positioned within joints 106, 108, 110, 112, it is recognized that pumps 124, 126, 128, 130 and accumulators 132, 134, 136, 138 may be positioned at other locations within tube assemblies 80, 82, 84, 86 in alternative embodiments. In another embodiment, one or more pumps 124, 126, 128, 130 may be positioned outside its respective tube assembly 80, 82, 84, 86 and fluidically coupled to tube assembly 80, 82, 84, 86 via a valve or other coupling device (not shown).

Additionally, FIGS. 4-6 depict the electrical connections between the various components of propulsion apparatus 74. As previously discussed, while FIGS. 4-6 depict the use of four (4) tube assemblies 80, 82, 84, 86, it is contemplated that more or less than four (4) tube assemblies 80 may be used. As such, the description of the electrical connections will be with respect to four (4) tube assemblies 80, 82, 84, 86. In this embodiment of the invention, a first lead wire 146 is electrically connected between pump 124 of first tube assembly 80 and a first contact 148. A second lead wire 150 is electrically connected between pump 126 of second tube assembly 82 and a fourth contact 160. Also, a third lead wire 154 is electrically connected between pump 128 of third tube assembly 84 and a third contact 156. In addition, a fourth lead wire 158 is electrically connected between pump 130 of fourth tube assembly 86 and a second contact 152. Finally, a ground lead wire 162 is electrically connected between pump 124, 126, 128, 130 of each tube assembly 80, 82, 84, 86 and a ground contact 164. Further, any metal components of tube assemblies 80, 82, 84, 86 may be likewise grounded via ground lead wire 162.

As shown in FIGS. 4-6, electrical contacts 148-160 are vertically spaced apart from each other along a length of an electrical hub 166 centrally located on rotating plate 76 and configured to maintain electrical contact between lead wires 146, 150, 154, 158 and their respective contacts 148, 160, 156, 152 as rotating plate 76 rotates about central axis 89. While FIGS. 4-6 illustrate one exemplary configuration for electrical contacts 148-160, one skilled in the art will recognize that electrical connections to tube assemblies 80-86 may be made in alternative manners. Likewise it is contemplated that ground contact 164 may also be disposed elsewhere on rotating plate 76 in alternative embodiments.

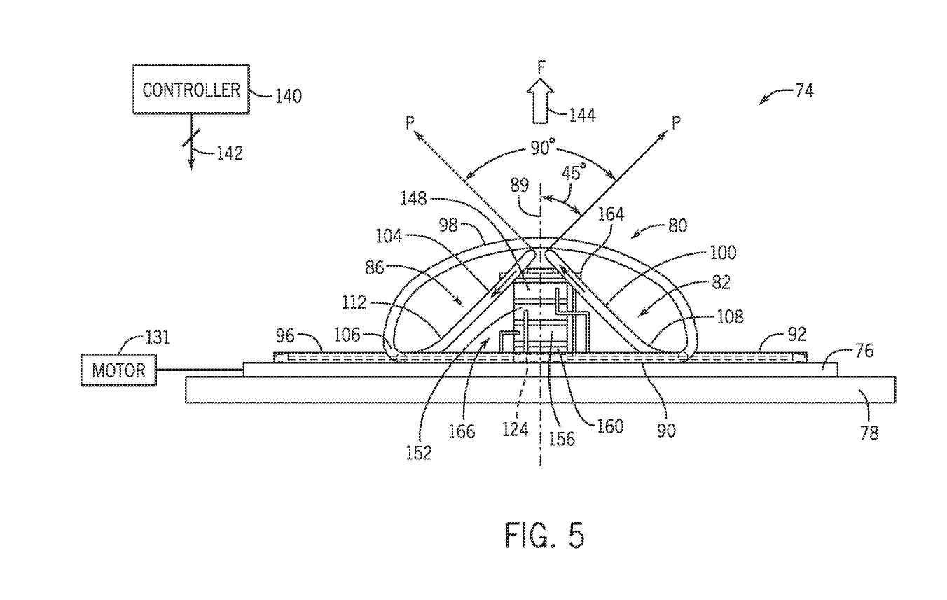

Propulsion apparatus 74 also includes a motor 131 coupled to rotating plate 76 and configured to cause plate 76 to rotate about central axis 89 at a variable range of speeds. Similar to propulsion apparatus 10, motor 131 include a gear assembly that is configured to intermesh with a corresponding gear assembly of rotating plate 76. In addition, propulsion apparatus 74 includes a controller or control system control system 140, schematically illustrated in FIG. 5, which is programmed to control operation of each pump 124, 126, 128, 130 and rotation of motor 131 via control lines 142. In one embodiment of the invention, motor 131 is controlled to cause rotating plate 76 to rotate in a counter-clockwise direction while each pump 124, 126, 128, 130 is controlled to simultaneously move fluid 116, 118, 120, 122 in a clockwise direction through its respective tube assembly 80, 82, 84, 86. Controller 140 may also be configured to control pumps 124, 126, 128, 130 to vary the flow rate of fluid 116, 118, 120, 122 during operation. Further, controller 140 may be configured to control pumps 124-130 independently, such that the fluid flow rate differs between tube assemblies 80-86.

Movement of propulsion apparatus 74 is accomplished by pumping fluid 116-122 through tube assemblies 80-86 while simultaneously rotating plate 76 about central axis 89. As plate 76 rotates, fluids 116-122 exert an outward-facing force (P) acting against its respective tube assembly 80-86. Together, fluids 116-122 generate a resultant force (F) acting in the direction of arrow 144. The magnitude of the resultant force (F) may be selectively controlled by adjusting the flow rate of fluids 116, 118, 120, 122 through tube assemblies 80, 82, 84, 86 and/or by adjusting the rotation speed of the rotating plate 76.

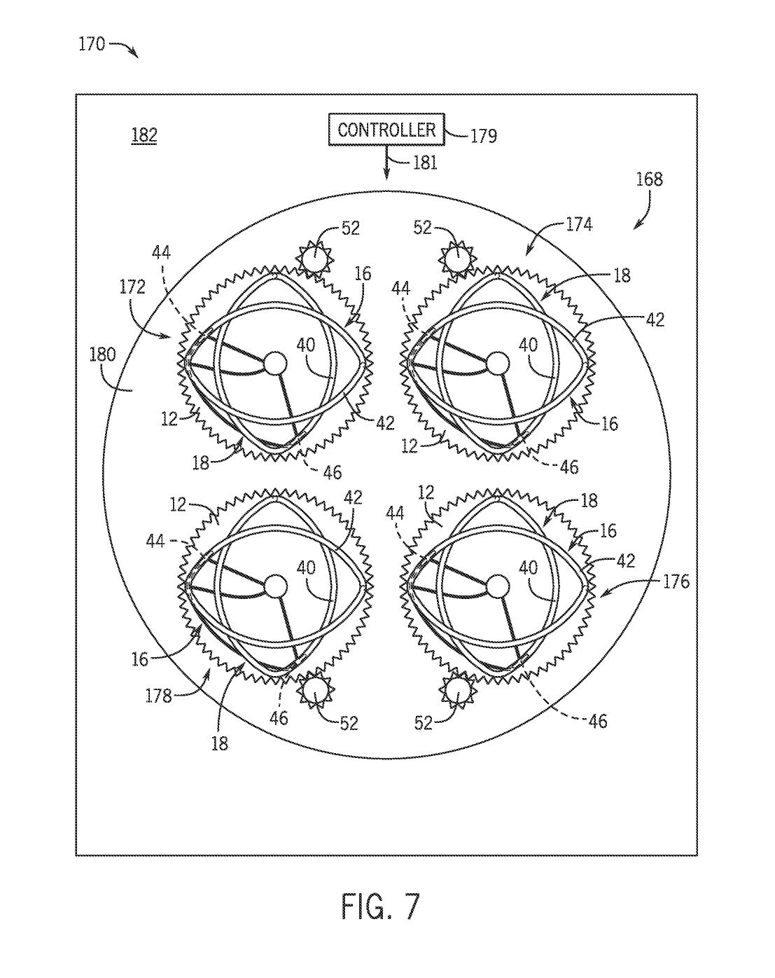

Now referring to FIG. 7, a propulsion system 168 is illustrated, according to another embodiment of the invention. As shown, propulsion system 168 is incorporated within the body 182 of a vehicle 170 and includes four (4) propulsion apparatuses 172, 174, 176, 178 that are provided on a vehicle mounting platform 180 and arranged in an evenly spaced orientation. As described in detail below, propulsion apparatuses 172, 174, 176, 178 together operate as a four-bladed propeller to effect motion of vehicle 170, which may be a space or air vehicle in alternative embodiments. While momentum propulsion system 168 is shown as using four (4) propulsion apparatus 10, it is contemplated that momentum propulsion system 168 may use more or less than four (4) propulsion apparatuses 74 in alternative embodiments.

In the embodiment shown, each propulsion apparatuses 172-178 are configured in a similar manner as propulsion apparatus 10 of FIGS. 1-3 and includes a first tube assembly 16 and a second tube assembly 18 mounted on a rotating disk 12, corresponding pumps 44, 46 to control a rate of flow of fluid 40, 42, and a motor 52 coupled to each rotating disk 12 to control rotation thereof. In an alternative embodiment, propulsion apparatuses 172-178 may be configured in a similar manner as propulsion apparatus 74 of FIGS. 4-6.

A control system 179 is provided within vehicle body 182 and is operationally coupled to each propulsion apparatus 172-178 via control lines 181. Control system 179 independently operates each propulsion apparatus 172-178 in order to control the steering and speed of vehicle 170. By independently controlling the rotational speed and/or fluid flow rate of each propulsion apparatus 172, 174, 176, 178, control system 179 can regulate whether the propulsion apparatuses 172-178 produce the same or different resultant forces.

In one embodiment, propulsion apparatuses 172, 176 may be controlled to rotated in an opposite direction as propulsion apparatuses 174, 178 for torque cancellation. According to one non-limiting example, motors 52 of rotating disks 12 of propulsion apparatuses 172, 176 may be rotated in a clockwise direction to cause counterclockwise rotation of respective rotating disks 12, while motors 52 of rotating disks 12 of propulsion apparatuses 174, 178 may be rotated in a counterclockwise direction to cause clockwise rotation of respective rotating disks 12. In such an embodiment, fluid is pumped through propulsion apparatuses 172, 176 in a clockwise direction, while fluid is pumped through propulsion apparatuses 174, 178 in a counterclockwise direction.

The steering of vehicle 170 may be controlled by causing propulsion apparatuses 172-178 to produce different resultant forces. For example, the fluid within propulsion appartuses 172-178 may be pumped at different flow rates for trim control in embodiments where vehicle 170 is an aircraft. The speed of vehicle 170 may be controlled by adjusting the magnitude of net force generated by all of the propulsion apparatuses 172-178.

For example, when propulsion apparatuses 172-178 are controlled to generate the same resultant forces, the net resultant force acting on vehicle 170 would produce a vertical lift. Increasing or decreasing the rotation and/or fluid flow rate of propulsion apparatuses 172-178 would change the speed of that lift. However, if propulsion apparatuses 174, 176 (located on the right side of vehicle mounting platform 180) were operated to generate a larger resultant force than that of propulsion apparatuses 172, 178 (located on the left side of vehicle mounting platform 180), vehicle 170 would tilt to the left and proceed in that direction. As a result, by operating each propulsion apparatus 172, 174, 176, 178 independently, vehicle 170 can controlled to move up, down, left, right, forward, backward, or any combination thereof.

In the illustrated embodiment, each propulsion apparatus 172-178 includes its own individual motor 52 which may be controlled to independently regulate the speed of each propulsion apparatus 172-178. In alternative embodiments, a single motor may be provided to control rotation of all four propulsion apparatuses 172-178. In such an embodiment, steering control may be provided by independently regulating the rate of fluid flow within each propulsion apparatus 172-178.

Vehicle 170 may be a land, air, or space vehicle, according to alternative embodiments. Where vehicle 170 is a land vehicle, vehicle 170 may further include a set of wheels (not shown) coupled to vehicle body 182. In such an embodiment, vehicle mounting platform 180 is oriented within vehicle body 182 such that propulsion apparatuses 172-178 may be controlled to generate a net resultant force to propel the vehicle 170 forwards and backwards and to steer the vehicle 170. Backwards control may be affected by reversing the rotation of propulsion apparatus 172-178.

Accordingly, embodiments of the propulsion apparatus disclosed herein are constructed and operated in such a manner so as to generate a propulsive force that may be used to propel an air or space vehicle in a desired direction. The propulsion apparatus combines the novel “bent” circular tube configuration of the tube assembly, the selective control of the rotating plate, and the selective control of fluid flow within the tube assembly. Operation in this manner generates a propulsive force as a result of the angular momentum of fluid flowing through the tube apparatus of the propulsion apparatus that generally resists changes in direction, thereby leveraging gyroscopic principles to achieve propulsion in a controlled and efficient manner.

A technical contribution for the disclosed method and apparatus is that it provides for a controller-implemented technique for propelling a vehicle.

Therefore, according to one embodiment of the invention, a propulsion apparatus includes a support structure and a first tube assembly coupled to the support structure. The first tube assembly includes a first curved portion, a second curved portion coupled to the first curved portion by a pair of angled joints, and a pump configured to pump a fluid through the first and second curved portions of the first tube assembly. The propulsion apparatus further includes a motor coupled to the support structure and a control system coupled to the motor and the pump and configured to propel the propulsion apparatus by simultaneously controlling a rotation of the support structure and a flow of the fluid within the first tube assembly.

According to another embodiment of the invention, a method of propelling a vehicle includes pumping a fluid through a plurality of tube assemblies, each tube assembly having a pair of joints dividing the tube assembly into a first curved section and a second curved section, wherein the first curved section is oriented at an angle to the second curved section. The method further includes propelling the vehicle in a direction by simultaneously controlling rotation of support structures coupled to the plurality of tube assemblies, and controlling a rate of flow of the fluid within the plurality of tube assemblies.

According to yet another embodiment of the invention, a vehicle includes a vehicle body, a mounting platform positioned within the vehicle body, and a plurality of propulsion apparatuses. Each propulsion apparatus includes a rotatable plate coupled to the mounting platform and a plurality of tube assemblies coupled to the rotatable plate. Each tube assembly of the plurality of tube assemblies includes a first curved portion and a second curved portion oriented at an angle to the first curved portion, a fluid disposed within the first and second curved portions and a pump configured to pump the fluid through the first and second curved portions. The vehicle further includes at least one motor coupled to the plurality of propulsion apparatuses and configured to cause rotation of the rotating plates and a propulsion control system configured to affect a motion of the vehicle by regulating a speed of the rotation of the plurality of rotating plates and a rate of flow of the fluid in the plurality of tube assemblies.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A propulsion apparatus comprising:
a support structure;
a first tube assembly coupled to the support structure, the first tube assembly comprising:
a first curved portion;
a second curved portion coupled to the first curved portion by a pair of angled joints; and
a pump configured to pump a fluid through the first and second curved portions of the first tube assembly;
a motor coupled to the support structure; and
a control system coupled to the motor and the pump and configured to propel the support structure by simultaneously controlling a rotation of the support structure and a flow of the fluid within the first tube assembly.

2. The propulsion apparatus of claim 1 wherein the first tube assembly is coupled to the support structure via at least one joint of the pair of angled joints; and
wherein the first curved portion and the second curved portion are spaced apart from a top surface of the support structure.

3. The propulsion apparatus of claim 1 wherein the first curved portion is oriented substantially orthogonal to the second curved portion.

4. The propulsion apparatus of claim 1 wherein the first curved portion is in contact with a top surface of the support structure and substantially co-planar with the top surface of the support structure; and
wherein the second curved portion is spaced apart from the top surface of the support structure.

5. The propulsion apparatus of claim 1 wherein the first curved portion is oriented at an angle obtuse to the second curved portion.

6. The propulsion apparatus of claim 1 wherein the control system is configured to:
rotate the support structure in a counter-clockwise direction; and
cause the fluid to flow in a clockwise direction within the first and second curved portions of the tube assembly.

7. The propulsion apparatus of claim 1 further comprising a second tube assembly coupled to the support structure, the second tube assembly comprising:
a first curved portion;
a second curved portion coupled to the first curved portion by a pair of angled joints; and
a pump configured to pump a fluid through the first and second curved portions of the second tube assembly.

8. The propulsion apparatus of claim 7 wherein a central axis of the first tube assembly is orientated substantially perpendicular to a central axis of the second tube assembly.

9. The propulsion apparatus of claim 7 wherein the control system is configured to control a rate of flow of the fluid in the first tube assembly to differ from a rate of flow of the fluid in the second tube assembly.

10. A method of propelling a vehicle comprising:
pumping a fluid through a plurality of tube assemblies, each tube assembly having a pair of joints dividing the tube assembly into a first curved section and a second curved section, wherein the first curved section is oriented at an angle to the second curved section; and
propelling the vehicle in a direction by simultaneously:
controlling rotation of support structures coupled to the plurality of tube assemblies; and
controlling a rate of flow of the fluid within the plurality of tube assemblies.

11. The method of claim 10 further comprising steering the vehicle by independently controlling a rotational speed and a rate of fluid flow of each of the plurality of tube assemblies.

12. The method of claim 11 further comprising:
pumping the fluid through a first tube assembly of the plurality of tube assemblies at a first flow rate; and
simultaneously pumping the fluid through a second tube assembly of the plurality of tube assemblies at a second flow rate, different from the first flow rate.

13. The method of claim 11 further comprising:
rotating a support structure of a first tube assembly of the plurality of tube assemblies at a first speed; and
rotating a support structure of a second tube assembly of the plurality of tube assemblies at a second speed, different from the first speed.

14. A vehicle comprising:
a vehicle body;
a mounting platform positioned within the vehicle body;
a plurality of propulsion apparatuses, each propulsion apparatus comprising:
a rotatable plate coupled to the mounting platform;
a plurality of tube assemblies coupled to the rotatable plate, each tube assembly of the plurality of tube assemblies comprising:
a first curved portion and a second curved portion oriented at an angle to the first curved portion;
a fluid disposed within the first and second curved portions; and
a pump configured to pump the fluid through the first and second curved portions;
at least one motor coupled to the plurality of propulsion apparatuses and configured to cause rotation of the rotating plates; and
a propulsion control system configured to affect a motion of the vehicle by regulating a speed of the rotation of the plurality of rotating plates and a rate of flow of the fluid in the plurality of tube assemblies.

15. The vehicle of claim 14 wherein the first curved portion and the second curved portion of a respective tube assembly of the plurality of tube assemblies are spaced apart from a top surface of a respective rotatable plate.

16. The vehicle of claim 14 wherein the first curved portion of a respective tube assembly of the plurality of tube assemblies is in contact with a top surface of a respective rotatable plate, and the second curved portion of the respective tube assembly is spaced apart from the top surface of the respective rotatable plate.

17. The vehicle of claim 14 further comprising a plurality of motors, wherein each of the plurality of motors is coupled to a respective one of the plurality of rotating plates.

18. The vehicle of claim 14 wherein the propulsion control system is configured to steer the vehicle by controlling one propulsion apparatus of the plurality of propulsion apparatuses to rotate at a first speed and controlling another propulsion apparatus of the plurality of propulsion apparatuses at a second speed, different from the first speed.

19. The vehicle of claim 14 further comprising four propulsion apparatuses.

20. The vehicle of claim 14 wherein a propulsion apparatus of the plurality of propulsion apparatuses comprises four tube assemblies.
